(19) United States
(12) Patent Application Publication
(10) Pub. No.: US 2026/0159782 A1
(43) Pub. Date: Jun. 11, 2026

(54) NON-FLAMMABLE AEROSOL FORMULATIONS CONTAINING 1,1,1,3,3,3-HEXAFLUORO-2-METHOXY PROPANE

(71) Applicant: Illinois Tool Works Inc., Glenview, IL (US)

(72) Inventor: Paul M. Blair, Jonesboro, GA (US)

(21) Appl. No.: 19/406,108

(22) Filed: Dec. 2, 2025

Related U.S. Application Data
(60) Provisional application No. 63/729,117, filed on Dec. 6, 2024.

(51) Int. Cl. C11D 7/30; C11D 7/50; C11D 17/00

(52) U.S. Cl. CPC C11D 7/30; C11D 7/5018; C11D 7/5022; C11D 17/0043

(57) ABSTRACT

The present disclosure relates generally to a non-flammable aerosol formulation containing 1,1,1,3,3,3-hexafluoro-2-methoxy propane (also known as HFMOP). The non-flammable aerosol formulation may be used for aerosol cleaning. The non-flammable aerosol formulation may also contain trans-1,2-dichloroethene (trans DCE), an alcohol such as methanol or ethanol, or another organic cleaning solvent such as acetone. The non-flammable aerosol formulation may also contain 1,1,1,2-tetrafluoroethane (HFC134a), trans-1,3,3,3-tetrafluoropropene (HFO1234ze), or carbon dioxide. The non-flammable aerosol formulation may contain other hydrofluoroethers (HFEs) and hydrofluoroolefins (HFOs).

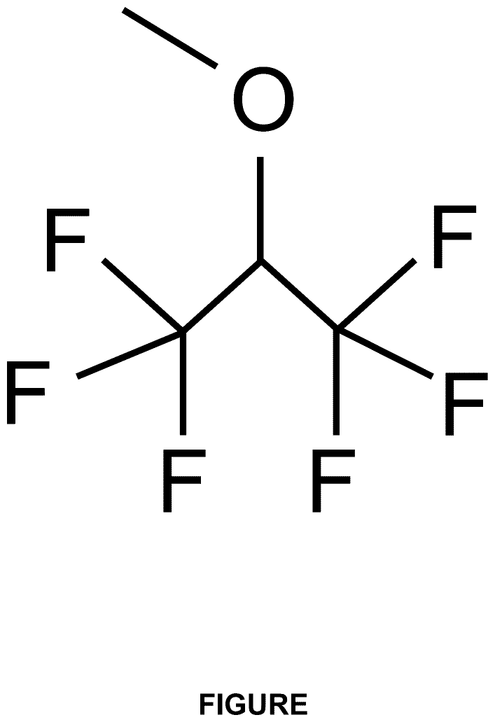

### CROSS-REFERENCE TO RELATED APPLICATIONS

This application claims the benefit of priority to U.S. provisional patent application No. 63/729,117, entitled “NON-FLAMMABLE AEROSOL FORMULATIONS CONTAINING 1,1,1,3,3,3-HEXAFLUORO-2-METHOXY PROPANE”, filed Dec. 6, 2024, the contents of which are herein incorporated by reference in their entirety.

### FIELD

The present disclosure relates generally to non-flammable aerosol formulations containing 1,1,1,3,3,3-hexafluoro-2-methoxy propane (also known as HFMOP or hexafluoroisopropyl methyl ether).

### BACKGROUND

Non-flammable aerosol cleaning products are required in certain situations, including service and repair of mission critical electronics that cannot be powered off or cannot be removed from a fire sensitive environment such as mission critical manufacturing sites (especially those which have cleanrooms), refineries and chemical factories, oil platforms, ships, telecommunication hubs, and data centers.

Current non-flammable aerosol cleaning products usually include one or more of each of: (A) fluorinated hydrocarbons, (B) organic cleaning solvents, and (C) non-flammable propellants. The fluorinated hydrocarbons typically provide flammability suppression and lower surface tension, and may include HFEs (hydrofluoroethers), HFOs (hydrofluoroolefins, which may also include hydrochlorofluoroolefins or HCFOs), and HFCs (hydrofluorocarbons). The organic cleaning solvents typically provide most of the cleaning strength and may include trans-1,2-dichloroethylene (also known as trans DCE, trans, or DCE), alcohols (including methanol and ethanol), and various other organics (including acetone and combinations of organics). The non-flammable propellants may also suppress flammability and include HFCs such as 1,1,1,2-tetrafluoroethane (also known as HFC134a), HFOs or HCFOs such as trans-1,3,3,3-tetrafluoropropene (also known as HFO1234ze), and carbon dioxide (CO2).

HFCs and some HFEs tend to have very high global warming potential (GWP). Thus, while they may be effective, there is a need for a non-flammable aerosol cleaning that has a lower GWP and does not contain PFAS (poly-perfluoroalkyl substances).

### SUMMARY

According to an aspect of the present disclosure, a non-flammable aerosol solution may comprise 1,1,1,3,3,3-hexafluoro-2-methoxy propane (HFMOP). The non-flammable aerosol solution may further comprise trans-1,2-dichloroethene (trans DCE). The non-flammable aerosol solution may further comprise 1,1,1,2-tetrafluoroethane (HFC134a), trans-1,3,3,3-tetrafluoropropene (HFO1234ze), or a combination of 1,1,1,2-tetrafluoroethane and trans-1,3,3,3-tetrafluoropropene. The non-flammable aerosol solution may further comprise carbon dioxide.

According to another aspect of the present disclosure, a non-flammable aerosol solution may consist of: HFMOP; trans DCE; HFC134a, HFO1234ze, or a combination of HFC134a and HFO1234ze; methanol, ethanol, or a combination of methanol and ethanol; carbon dioxide; and other hydrofluoroethers (HFEs) and hydrofluoroolefins (HFOs).

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The following is a description of the examples depicted in the accompanying drawings. The figures are not necessarily to scale, and certain features and certain views of the figures may be exaggerated in scale or in schematic for clarity or conciseness.

The FIGURE illustrates a skeletal structural formula of 1,1,1,3,3,3-hexafluoro-2-methoxy propane (also known as HFMOP or hexafluoroisopropyl methyl ether).

The foregoing summary, as well as the following detailed description, will be better understood when read in conjunction with the figures. It should be understood that the claims are not limited to the arrangements and instrumentality shown in the figures. Furthermore, the appearance shown in the figures is one of many ornamental appearances that can be employed to achieve the stated functions of the apparatus.

### DETAILED DESCRIPTION

In the following detailed description, specific details may be set forth to provide a thorough understanding of the embodiments of the present disclosure. However, it will be clear to one skilled in the art when disclosed examples may be practiced without some or all of these specific details. For the sake of brevity, well-known features or processes may not be described in detail. In addition, like or identical reference numerals may be used to identify common or similar elements.

One or more specific embodiments of the present disclosure will be described below. In an effort to provide a concise description of these embodiments, all features with an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

1,1,1,3,3,3-hexafluoro-2-methoxy propane (also known as HFMOP or hexafluoroisopropyl methyl ether) is an HFE with a very low global warming potential (GWP). HFMOP has CAS Registry Number 13171-18-1. In the latest assessment by the IPCC (Intergovernmental Panel on Climate Change) HFMOP was found to have a GWP of 8.13 (100 year carbon dioxide has a GWP of 1). Under EPA TSCA Rule 8 (a) (7), HFMOP is classified as a non-PFAS. As such, there appears to be potential for aerosol formulations containing HFMOP.

According to certain aspects of the present disclosure, a non-flammable aerosol cleaning solution may comprise 1,1,1,3,3,3-hexafluoro-2-methoxy propane (HFMOP) as a fluorinated hydrocarbon, along with an organic cleaning solvent and a non-flammable propellant. The HFMOP may provide flammability suppression and lower surface tension. The organic cleaning solvent may provide most of the cleaning strength of the cleaning solution. The non-flammable propellant may both act as a propellant and suppress flammability. In some embodiments, the organic cleaning solution may comprise trans-1,2-dichloroethene (trans DCE), an alcohol such as methanol or ethanol, or another organic cleaning solvent such as acetone. In some embodiments, the non-flammable propellant may comprise 1,1,1,2-tetrafluoroethane (HFC134a), trans-1,3,3,3-tetrafluoropropene (HFO1234ze), or carbon dioxide. In another embodiment, the non-flammable propellant may comprise 1-chloro-3,3,3-trifluoropropene (HFO1233zd (Z)). In certain embodiments, the non-flammable aerosol cleaning solution may comprise other hydrofluoroethers (HFEs) and hydrofluoroolefins (HFOs), such as HFO1233zd (Z), HFE347 isomers, HFO1233 isomers (including yd and yf), HFE449s1 isomers (also known as HFE7100), HFE569sf2 isomer (also known as HFE7200), HFO1336 isomers, and HFE356 isomers (for example HFE356mec3).

According to certain aspects of the present disclosure, a non-flammable aerosol cleaning solution may comprise 20-70, or 30-60, or 40-50 wt. % HFMOP; 25-50, or 30-45, or 35-45 wt. % trans DCE; 10-25, or 12-22, or 15-20 wt. % HFC134a or HFO1234ze (or a combination thereof); 1-5, or 2-4, or 3 wt. % methanol or ethanol (or a combination thereof); 1-6, or 2-5, or 3-4 wt. % carbon dioxide; and 0-50, or 20-45, or 25-44, or 30-43, or 35-40 wt. % of another HFE or HFO (such as HFO1233zd (Z), HFE347 isomers, HFO1233 isomers (including yd and yf), HFE449s1 isomers (also known as HFE7100), HFE569sf2 isomer (also known as HFE7200), HFO1336 isomers, and HFE356 isomers (for example HFE356mec3)).

Table 1 shows example formulations of a non-flammable aerosol cleaning solution according to the present disclosure.

TABLE 1
Six Example Formulations of a Non-Flammable Aerosol Cleaning Solution.

| Component | Example 1 | Example 2 | Example 3 | Example 4 | Example 5 | Example 6 |
|---|---|---|---|---|---|---|
| HFMOP | 20% to 70% | 20% to 70% | 20% to 70% | 20% to 70% | 20% to 70% | 20% to 70% |
| Trans DCE | 25% to 50% | 25% to 50% | 25% to 50% | 25% to 50% | 25% to 50% | 25% to 50% |
| HFC134a | 10% to 25% | 10% to 25% | | | 10% to 25% | |
| HFO1234ze | | | 10% to 25% | 10% to 25% | | 10% to 25% |
| CO₂ | 1% to 6% | 1% to 6% | 1% to 6% | 1% to 6% | 1% to 6% | 1% to 6% |
| Methanol | 1% to 5% | | 1% to 5% | | | |
| Ethanol | | 1% to 5% | | 1% to 5% | | |
| Other HFE or | 0% to 43% | 0% to 43% | 0% to 43% | 0% to 43% | 0% to 44% | 0% to 44% |
| HFO | | | | | | |

One advantage of the disclosed non-flammable aerosol cleaning solutions is that they have a lower global warming potential (GWP) compared to existing aerosol cleaning solutions.

The various aspects and embodiments disclosed herein are not intended to be limiting. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

1. A non-flammable aerosol solution comprising 1,1,1,3,3,3-hexafluoro-2-methoxy propane.

2. The non-flammable aerosol solution of claim 1, further comprising trans-1,2-dichloroethene.

3. The non-flammable aerosol solution of claim 1, further comprising 1,1,1,2-tetrafluoroethane, trans-1,3,3,3-tetrafluoropropene, or a combination of 1,1,1,2-tetrafluoroethane and trans-1,3,3,3-tetrafluoropropene.

4. The non-flammable aerosol solution of claim 1, further comprising methanol, ethanol, or a combination of methanol and ethanol.

5. The non-flammable aerosol solution of claim 1, further comprising carbon dioxide.

6. The non-flammable aerosol solution of claim 1, comprising 20 to 70 wt. % 1,1,1,3,3,3-hexafluoro-2-methoxy propane.

7. The non-flammable aerosol solution of claim 6, further comprising 25 to 50 wt. % trans-1,2-dichloroethene.

8. The non-flammable aerosol solution of claim 7, further comprising 10 to 25 wt. % 1,1,1,2-tetrafluoroethane, trans-1,3,3,3-tetrafluoropropene, or a combination of 1,1,1,2-tetrafluoroethane and trans-1,3,3,3-tetrafluoropropene.

9. The non-flammable aerosol solution of claim 7, further comprising 1 to 5 wt. % methanol, ethanol, or a combination of methanol and ethanol.

10. The non-flammable aerosol solution of claim 7, further comprising 1 to 6 wt. % carbon dioxide.

11. The non-flammable aerosol solution of claim 8, further comprising 1 to 5 wt. % methanol, ethanol, or a combination of methanol and ethanol; and 1 to 6 wt. % carbon dioxide.

12. A non-flammable aerosol solution consisting of:
1,1,1,3,3,3-hexafluoro-2-methoxy propane;
trans-1,2-dichloroethene;
1,1,1,2-tetrafluoroethane, trans-1,3,3,3-tetrafluoropropene, or a combination of 1,1,1,2-tetrafluoroethane and trans-1,3,3,3-tetrafluoropropene;
methanol, ethanol, or a combination of methanol and ethanol;
carbon dioxide; and
other hydrofluoroethers (HFEs) and hydrofluoroolefins (HFOs).

13. The non-flammable aerosol solution of claim 12 consisting of:
20 to 70 wt. % 1,1,1,3,3,3-hexafluoro-2-methoxy propane;
25 to 50 wt. % trans-1,2-dichloroethene;
10 to 25 wt. % 1,1,1,2-tetrafluoroethane, trans-1,3,3,3-tetrafluoropropene, or a combination of 1,1,1,2-tetrafluoroethane and trans-1,3,3,3-tetrafluoropropene;
1 to 5 wt. % methanol, ethanol, or a combination of methanol and ethanol;
1 to 6 wt. % carbon dioxide; and
20 to 50 wt. % other HFEs and HFOs.

14. The non-flammable aerosol solution of claim 12 consisting of:
20 to 70 wt. % 1,1,1,3,3,3-hexafluoro-2-methoxy propane;
25 to 50 wt. % trans-1,2-dichloroethene;
10 to 25 wt. % 1,1,1,2-tetrafluoroethane;
1 to 5 wt. % ethanol;
1 to 6 wt. % carbon dioxide; and
20 to 50 wt. % other HFEs and HFOs.

15. The non-flammable aerosol solution of claim 12 consisting of:
20 to 70 wt. % 1,1,1,3,3,3-hexafluoro-2-methoxy propane;
25 to 50 wt. % trans-1,2-dichloroethene;
10 to 25 wt. % 1,1,1,2-tetrafluoroethane;
1 to 5 wt. % methanol;
1 to 6 wt. % carbon dioxide; and
20 to 50 wt. % other HFEs and HFOs.

16. The non-flammable aerosol solution of claim 12 consisting of:
20 to 70 wt. % 1,1,1,3,3,3-hexafluoro-2-methoxy propane;
25 to 50 wt. % trans-1,2-dichloroethene;
10 to 25 wt. % trans-1,3,3,3-tetrafluoropropene;
1 to 5 wt. % ethanol;
1 to 6 wt. % carbon dioxide; and
20 to 50 wt. % other hydrofluoroethers (HFEs) and hydrofluoroolefins (HFOs).

17. The non-flammable aerosol solution of claim 12 consisting of:
20 to 70 wt. % 1,1,1,3,3,3-hexafluoro-2-methoxy propane;
25 to 50 wt. % trans-1,2-dichloroethene;
10 to 25 wt. % trans-1,3,3,3-tetrafluoropropene;
1 to 5 wt. % methanol;
1 to 6 wt. % carbon dioxide; and
20 to 50 wt. % other hydrofluoroethers (HFEs) and hydrofluoroolefins (HFOs).

18. The non-flammable aerosol solution of claim 12 consisting of:
20 to 70 wt. % 1,1,1,3,3,3-hexafluoro-2-methoxy propane;
25 to 50 wt. % trans-1,2-dichloroethene;
10 to 25 wt. % 1,1,1,2-tetrafluoroethane;
1 to 6 wt. % carbon dioxide; and
20 to 50 wt. % other HFEs and HFOs.

19. The non-flammable aerosol solution of claim 12 consisting of:
20 to 70 wt. % 1,1,1,3,3,3-hexafluoro-2-methoxy propane;
25 to 50 wt. % trans-1,2-dichloroethene;
10 to 25 wt. % trans-1,3,3,3-tetrafluoropropene;
1 to 6 wt. % carbon dioxide; and
20 to 50 wt. % other hydrofluoroethers (HFEs) and hydrofluoroolefins (HFOs).
